(19) United States
(12) Patent Application Publication
(10) Pub. No.: US 2007/0259329 A1
(43) Pub. Date: Nov. 8, 2007

(54) Anergy-inducing cellular composition

(75) Inventors: Jong-Yoon Kim, Kamigyo-ku (JP); Kazuaki Matsumura, Kamigyo-ku (JP); Yasuhiro Iwanaga, Sakyo-ku (JP); Hajime Sugai, Kamigyo-ku (JP); Suong-Hyu Hyon, Sakyo-ku (JP)

Correspondence Address: JORDAN AND HAMBURG LLP, 122 EAST 42ND STREET, SUITE 4000, NEW YORK, NY, 10168, US

(73) Assignee: BioVerde. Inc., Higashigawa (JP)

(21) Appl. No.: 11/418,422

(22) Filed: May 3, 2006

(51) Int. Cl. A01N 1/02

(52) U.S. Cl. 435/2

(57) ABSTRACT

The invention is directed to an anergy-inducing cellular composition comprising: cells having antigenic determinants on the cell surface and an anergy-inducing compound [e.g., (−)-epigallocatechin-3-o-gallate (EGCG)] attached by its chemical affinity to the antigenic determinants. In one embodiment, the anergy-inducing compound blocks co-stimulatory molecules among the antigenic determinants of the cells, which upon encountering with T-cell renders the latter anergic, that is, unresponsive toward alloantigens. In another embodiment, EGCG is of high purity for its efficient attachment to the antigenic determinants. The anergy-inducing cellular composition is prepared by immersing the cells in a culture media solution (RPMI 1640) containing 50-500 ppm EGCG at low physiological temperatures for one to two hours to minimize the cells' mortality. A specific use of the resulting anergic cellular composition is suggested, which is the attenuation of two undesirable acute allogenic responses resulting from major histocompatibility disparity, namely, transplant rejection and GVHD.

### FIELD OF THE INVENTION

The present invention relates to the preparation of anergy-inducing cellular compositions comprising living cells and anergy-inducing compound (−)-epigallocatechin-3-o-gallate (EGCG) attached to the antigenic determinants of the cells.

### BACKGROUND OF THE INVENTION

Full citations for referred publications pertaining to this application are listed at the end of the Detailed Description.

Tissue or organ transplantation is often indispensable for the treatment of many medical problems, but acute rejection of a transplant by a recipient's body frequently occurs due to a mismatch between a donor and a recipient. The recipient under such acute rejection is subject to a life-threatening situation. Graft-versus-host disease (GVHD) is another problem that threatens the recipient's life, where the T-cells remaining in the transplant attack the recipient's body system. In order to control these undesirable responses, tissue matching and pharmacological interventions have been employed. Because tissue matching is often unsuccessful and pharmacological methods produce potential side effects on other tissues or organs, more reliable and safer means have been invented. One is the antigenic modulation of cells, in which the cell or tissue surface is coated with polyethylene glycol by covalent bonds (Scott et al. 1997), and the other is the specific inhibition of T-cell activation by nuclear factors (Noguchi et al. 2004). The former is both a useful concept and a method of blocking allogenic recognition of foreign cells or endothelial surfaces and attenuating the occurrence of graft rejection and GVHD. However, these means require skillful or costly techniques for modulating cells or tissues thus are unavailable in most clinical situations.

To this end, we propose the use of (−)-epigallocatechin-3-o-gallate (EGCG) to modulate living cells of the transplant to induce anergy in T-cells, that is, the lack of responsiveness of the T-cells toward alloantigens.

EGCG in a liquid suspension readily adheres to cell surfaces at physiological temperatures due to the strong affinities of EGCG to macromolecules such as proteins and lipids on the surfaces of cells (Sazuka et al. 1996). EGCG and other closely-related compounds are also known to attach to the cell surface macromolecules, but EGCG is known to have by far the strongest affinity (Ashida et al. 2000). This property leads to the ideal method of attaching EGCG molecules to the cell surfaces, whereas EGCG is of high purity, because impurities that constitute such related compounds may competitively interfere the efficient attachment of EGCG.

The present invention utilizes a specific immuno-tolerance phenomenon called anergy, meaning that the T-cells are rendered unresponsive to alloantigens. To induce anergy, (1) cells must be alive in order to produce macromolecules and (2) specific macromolecules, namely co-stimulatory molecules, must be blocked by the attachment of EGCG. When these conditions are met, incomplete stimulation of the T-cells by the transplanted cells takes place. Therefore, an efficient method of inducing anergy must fulfill these two conditions. EGCG in the present invention was found to uniquely meet both due to its sufficient affinities to these macromolecules.

Following the preparation of the anergy-inducing cell, a transplant, which can be a cell, tissue or organ according to the methods described herein, it is transplanted to a recipient. The EGCG molecules on a cell surface of the transplant and T-cells remaining in the transplant interfere the interactions between co-stimulatory molecules and their ligands, rendering recipient and donor T-cells anergic, thereby, attenuating two undesirable acute allogenic responses resulting from major histocompatibility disparity, namely transplant rejection and GVHD, respectively.

Ikeguchi et al. (2005) disclose the method of treating nerve allografts with a polyphenol solution which contains a mixture of various polyphenolic compounds extracted from tea leaves. This method cannot appropriately induce anergy described in the present invention because, firstly, the solution contains numerous other related compounds whose physiological actions have not yet been defined and which may interfere the efficient attachment of EGCG to the macromolecules, and secondly, the high concentration (1000 ppm) of the polyphenolic compounds, to which the allografts were exposed for an extended period of time (4 weeks), will exert a direct toxicity to the cells on the surface of the allografts, thereby killing these cells and abrogating the ability of becoming anergy-inducing cells. Therefore, this method specifically violates the conditions for anergy induction. The concentrations of EGCG in the solution and treatment time, therefore, need to be adjusted between 50 and 500 ppm and 1-2 hours, which are crucial for the maintenance of the cells' viability as well as attaining sufficient affinities of EGCG toward co-stimulatory molecules.

U.S. Pat. No. 5,908,624 of Scott et al. discloses a detailed method of covalent binding of mPEG to cell surfaces (thus called PEGylation) that are antigenically camouflaged, and discusses various uses of the resulting cells to decrease rejection of transplanted cells and tissues. Compared to this particular method, the present invention utilizes a different compound which is attached to cells by chemical affinity. The latter method gives an incomplete stimulation to the recipient or donor T-cells when they encounter the cells of the transplant or the recipient tissues, where co-stimulatory molecules are blocked by EGCG, and it prevents the occurrences of graft rejection or GVHD, respectively.

Chen and Scott (2001) discuss further applications of the non-immunogenic cells and tissues with the mPEG binding to cell surfaces. Chen and Scott (2003) also discuss with a set of in vitro and in vivo murine experimental data that mPEG binding to cell surfaces prevents transfusion-induced GVHD. Scott and Chen (2004) then summarize the mechanisms and effects of immunocamouflage and suggest its potential future applications in clinical transplantations. In contrast, the present method does not render cells non-immunogenic but makes them anergy-inducing when encountering with recipient or donor T-cells.

Han (2003) found a suppression of cytokine-induced pancreatic β-cell damage by EGCG. This finding relates to a possible prevention of diabetes mellitus, an autoimmune disease, where the infiltrating immune cells secrete cytokines attacking syngeneic pancreatic cells. These immune mechanisms that may explain the autoimmune response are not related to the context of reducing allogenic immune responses by anergy induction which the present invention is directed to.

Masten (2001) reported data on EGCG including a number of its physiological actions such as reducing anti-inflammatory effects, blocking the production of tumor necrosis factor, and stimulating human monocyte and polymorphonuclear cell iodination. However, any of these actions are not described in nor directly related to the context of reducing allogenic immune responses by anergy induction which the present invention is directed to.

Sanbongi et al. (1997) found that a specific polyphenolic compound, namely (−)-epicatechin, inhibited proliferative responses of T-cells. This compound is essentially different from EGCG in its lack of gallate group, and the mechanism that the compound modulates immune function was not described in the context of reducing allogenic immune responses by anergy induction which the present invention is directed to.

Falchetti et al. (2001) found that a specific polyphenolic compound, namely resveratrol, at low concentrations (5-10 ppm) inhibited cytokine productions in antibody-stimulated peripheral blood mononuclear cells but at still lower concentrations (0.625-2.5 ppm) enhanced them. This compound is essentially different from EGCG and has chemical properties different from those of the latter. The mechanism with which resveratrol exhibited such enigmatic effects on cellular proliferation at the concentrations much lower than those used in the present invention is entirely unknown. In addition, the possible immune effects mentioned therein are not in the context of reducing allogenic immune responses by anergy induction which the present invention is directed to.

Japan 2000-344602A of Gen, Shokyu (which is synonymous with Hyon, Suong-Hyu, one of the inventors of this subject invention) discloses a detailed description of a tissue-preserving media containing a mixture of polyphenolic compounds including EGCG and discusses its uses for preserving various mammalian cells and tissues above freezing temperatures.

EP 1 057 405 A1 of Gen, Shokyu also discloses a detailed description of the same tissue preserving media containing a mixture of polyphenolic compounds including EGCG and discusses uses for preserving various mammalian cells and tissues above freezing temperatures.

### BRIEF SUMMARY OF THE INVENTION

The present invention provides for the anergy-inducing cellular compositions, where anergy is induced by using a specific polyphenolic compound, and uses of such anergy-inducing cells, particularly for the prevention of transplantation-related problems namely graft rejection and graft-versus-host disease (GVHD). The invention is useful in decreasing the ability of recipient or donor T-cells to respond to alloantigens.

In one embodiment, the polyphenolic compound is (−)-epigallocatechin-3-o-gallate (EGCG). The chemical property of EGCG in attaching to cell surface determinants and other macromolecules has been described (Sazuka et al. 1996), and the role of EGCG and its family compounds in agonistically inhibiting receptor-ligand interactions has been analyzed by affinity chromatography (Ashida 2000). It is hypothesized that this property is yielded by the chemical property that EGCG tends to have strong affinity with macromolecules such as antigenic determinants on cell surfaces in a liquid medium.

A potential application for the anergy-inducing cells is the attenuation of two undesirable acute allogenic responses resulting from major histocompatibility disparity, namely, transplant rejection and GVHD. Transplants (cells, tissues or organs) treated with the media solution containing EGCG according to the description discussed herein attenuate the acute rejection of themselves by the recipients. Transplanted cells, tissues or organs, if untreated, are recognized as foreign entities by the recipient and destroyed by phagocytes, antibodies and T-cells. Donor T-cells remaining in an untreated transplant attack its recipient in GVHD; thus, donor T-cells treated with EGCG are decreased of their propensity toward attacking the recipient's body system thus attenuate GVHD.

The subject invention states that (1) EGCG molecules can be attached to a transplant, which may be either cells, tissues or organs, by treating it with a media solution containing EGCG, that (2) the EGCG treatment of the transplant can block the co-stimulatory molecules for T-cell activation, that (3) the EGCG-treated transplant is decreased of its propensity toward being rejected by the recipient, and that (4) T-cells remaining in the EGCG-treated transplant are diminished of their propensity toward proliferating and attacking the recipient's body system.

The EGCG-containing media solution used for the preparation of the anergy-inducing cells described herein differs from the cell- or tissue-preserving solutions containing mixtures of polyphenols, whereas the former is specifically designed for efficient attachment of EGCG molecules to a transplant. The former contains high purity EGCG with the final concentration range between 50 to 500 ppm, which gives minimal physiological stresses to living cells and tissues. It is devoid of animal serum such as FCS, which may significantly decrease the amount of EGCG attaching to the target transplant. In addition, pH ranges and treatment temperatures and durations are specified for further optimizing the process of EGCG attachment and maintaining the viability of the transplant.

Allogenic rejection or GVHD of transplants occur in various biological systems such as cells, tissues or organs. Thus, the application of the present invention can also vary depending on kinds of transplants to be used in the form of liquid suspension (e.g. blood cells and pancreatic islets) or tissue blocks (e.g. vascular and nerve tissues) after being treated with EGCG. The application of this invention can also lead to the context of organ transplantation where a whole organ (e.g. kidney) with its intact vascular system can be immersed in the media solution containing EGCG before being transplanted to a recipient's body system and prevented from its rejection at the level of vascular endothelium.

### BRIEF DESCRIPTION OF THE SEVERAL VIEWS OF THE DRAWING

The utility of this invention is apparent in the light of the following description of preferred embodiments with the data shown in:

FIG. 1 shows the survival of murine splenocytes in the media solution containing EGCG at 4 degree C. Presented data are the average of three replicates for each treatment.

FIG. 2 shows the survival of murine splenocytes in the media solution containing EGCG at 37 degree C. Presented data are the average of three replicates for each treatment.

FIG. 3 shows one-way MLRs demonstrating that EGCG treatments attenuated allorecognition and resulted in a decrease of T-cell proliferation. Bold-typed C57BI/6 (responder cells) or BALB/c (stimulator cells) represents either C57BI/6 or BALB/c splenocytes treated with EGCG before MLR experiments. Mean values and standard deviations for triplicate samples are shown. Differences were significant between treated and untreated groups (*p<0.0001; **p<0.018) based on Fisher's PLSD.

FIG. 4 shows two-way MLRs demonstrating that EGCG treatments attenuated allorecognition and resulted in a decrease of T-cell proliferation. Bold-typed C57BI/6 (responder cells) or BALB/c (stimulator cells) represents either C57BI/6 or BALB/c splenocytes treated with EGCG before MLR experiments. Mean values and standard deviations for triplicate samples are shown. Differences were significant between treated and untreated groups (*p<0.0001) based on Fisher's PLSD.

FIG. 5 is a bar graph indicating percent viability of unstimulated splenocytes (C57BI/6 only). The viability of cells immediately following EGCG treatments represents 100% (not shown in the graphs), and that of 24, 48 and 72 hours represents the viability after 24, 48 and 72 hours of cell culture incubation.

FIG. 6 is a bar graph indicating percent viability of C57BI/6 splenocytes stimulated with BALB/c splenocytes. The viability of cells immediately following EGCG treatments represents 100% (not shown in the graphs), and that of 24, 48 and 72 hours represents the viability after 24, 48 and 72 hours of cell culture incubation.

FIG. 7 is a bar graph indicating the production of cytokines IL-2 in the one-way MLR cell cultures. Hatched bars represent the background levels of IL-2 production measured in unstimulated cultures. Mean values and standard deviations for triplicate samples are shown. Differences were significant between treated and untreated groups (p<0.0001) based on Fisher's PLSD.

FIG. 8 is a bar graph indicating the production of INF-γ in the one-way MLR cell cultures. Hatched bars represent the background levels of INF-γ production measured in unstimulated cultures. Mean values and standard deviations for triplicate samples are shown. Differences were significant between treated and untreated groups (p<0.0001) based on Fisher's PLSD.

FIG. 9 is a bar graph showing that the proliferation of C57BI/6 splenocytes co-cultured with EGCG-treated BALB/c splenocytes was sustained even after being stimulated again with untreated BALB/c splenocytes in one-way MLR or exogenous IL-2. Unstimulated blank (open bar) represents the culture without the secondary stimulation. Mean values and standard deviations for triplicate samples are shown. Differences were significant between treated and untreated groups for cell-stimulated cultures (p<0.0001) and IL-2-stimulated cultures (p<0.0001) based on fisher's PLSD.

FIG. 10 shows the diagrammatic representation of a cell to which EGCG adheres to the cell by means of its strong affinities to cell surface antigenic determinants and other membrane-associated molecules.

### DETAILED DESCRIPTION OF THE INVENTION

The subject invention provides for the anergy-inducing cell compositions, where anergy is induced by using a specific polyphenolic compound, and uses of such anergy-inducing cells, particularly for the prevention of transplantation-related problems namely graft rejection and graft-versus-host disease (GVHD). The specific polyphenolic compound is (−)-epigallocatechin-3-o-gallate (EGCG), which is attached to the cells at antigenic determinants, thus blocking allogenic immune responses. The invention is useful in the attenuation of two undesirable acute allogenic responses resulting from major histocompatibility disparity, namely, transplant rejection and GVHD.

The cells can be any suitable living cells or tissues with antigenic determinants on the cells' or tissues' surfaces. The suitable cells or tissues can include any anuclear or nucleated cells or groups of cells, for examples, red blood cells, platelets, lymphocytes, hematopoietic cells, vascular endothelial cells, hepatic cells, neuronal cells, glial cells, pancreatic cells, renal cells, cardiac myocytes, bronchial cells, pulmonary cells, epithelial cells, corneal cells and osteoblasts. These cells are examples only, and the invention is intended not to be limited to these specific examples. In addition to these living cells, any cryopreserved tissues such as aortas and veins may also constitute suitable tissues to be treated with EGCG after being thawed. The cryopreserved tissues are largely devoid of any functional antigenic determinants, but it is expected that EGCG still attaches to remaining antigenic determinants.

The antigenic determinants on the cell surface of a transplant can constitute antigenic proteins, antigenic carbohydrates, antigenic saccharides, antigenic lipids, antigenic glycolipids, antigenic glycoproteins, and so forth. These antigens are recognized as foreign entities by an immunologically-incompatible recipient, and the donor cell is subject to rapid destruction by means of the stimulation of phagocytes (innate immunity), antibodies (humoral immunity) or T-cells (cell-mediated immunity). In GVHD, these antigens of a recipient are recognized as foreign entities by the T-cells remaining in the incompatible donor tissues. To decrease these immune responses, the subject invention attenuates the antigenicity of the transplant or the stimulation of T-cells remaining in the transplant by attaching EGCG to the antigenic determinants of the transplant or the T-cells, respectively.

EGCG attaches to the antigenic determinants of a cell surface (FIG. 10) with its strong chemical affinity, which is exerted by any of the three chemical interactions: (1) the coulomb force between acidic hydroxide groups of EGCG and basic amino groups of the macromolecules, (2) the hydrophobic interaction between the benzene nuclei of EGCG and hydrophobic domains of the macromolecules, and (3) the hydrogen bond between EGCG and the macromolecules.

The invention provides the method of preparing anergy-inducing cells, that is, treating them with the media solution containing EGCG. This is accomplished by treating the transplant with the solution by either (1) making liquid suspensions of, for examples, blood cells and pancreatic islets, or (2) immersing tissue blocks such as blood veins in the media solution containing 50 to 500 ppm EGCG at 4 to 8 degree C. for 1-2 hours.

The invention specifies the contents of the media solution as well as the treatment methods. EGCG to be used must have the purity of 98% or greater in weight percentage scales, and the solution must be devoid of animal serum such as FCS which contains significant amounts of proteins that reduce the amount of EGCG attached to the surface macromolecules of the transplant or T-cells. Additionally, the pH of the solution is adjusted with HEPES buffer at around 7.0, which also increases the efficiency of EGCG attachment. The solution contains the culture media, RPMI 1640, to optimize the physiological conditions of the transplant or T-cells remaining in the transplant.

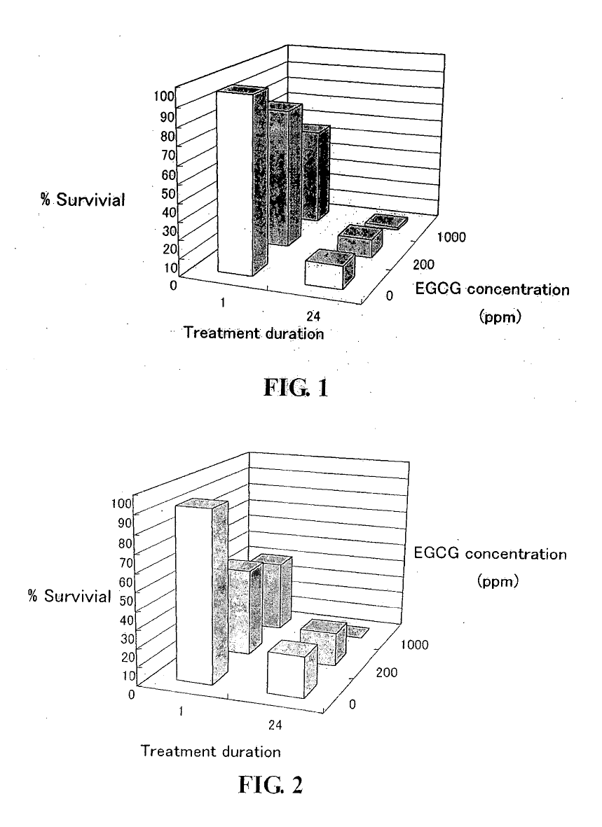

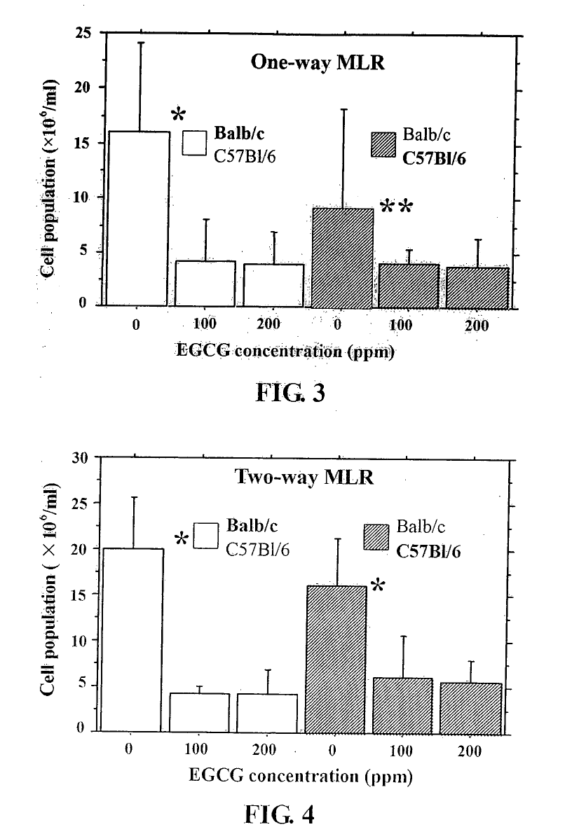

The treatment method presented herein specifies the ranges of EGCG concentrations, temperatures and durations, and these ranges are examples based on the experimental conditions used for the murine splenocytes (FIGS. 3 and 4). Exposure of these cells or other cells and tissues to higher EGCG concentrations or temperatures for a longer time may irreversibly change the functional and structural properties of the cells of the transplant and T-cells remaining in the transplant (FIGS. 1 and 2). Therefore, appropriate EGCG-treatment concentrations, temperatures and durations must be determined for the individual transplant in order to minimize various physiological stresses to it and maximize its viability and survival after transplantation.

The application of this invention can also lead to the context of organ transplantation where a whole organ with its intact vascular system can be treated with the EGCG-containing media solution before being transplanted to a recipient and prevented from its rejection at the level of vascular endothelium. The vascular endothelium of transplanted organs exposes an array of antigenic determinants, which are blocked by EGCG attached to these antigenic determinants. This will decrease the occurrence of organ rejections.

Practical applications of EGCG treatment for the cells, tissues or organs prior to transplantation include: 1) EGCG-treated cells, tissues or organs when transplanted to a recipient attenuate the acute rejection of themselves by the recipient, and 2) recipient T-cells remaining in the EGCG-treated tissues or organs are decreased of their propensity toward attacking the recipient's cells and tissues as foreign entities (GVHD). In the practical applications under an expected scenario of clinical transplantation, the cells, tissues or organs freshly harvested from a postmortem donor or cryopreserved tissues or organ parts that have been just thawed can be treated with the media solution containing EGCG for a few hours at 4-8 degree C. before being transplanted into a recipient.

The invention is useful in making cells of the transplant to become anergy-inducing without significant mortality to the cells or adverse effects to its recipient. In the application of the invention, the activation and proliferation of the recipient T-cells are not targeted unlike in commonly-used pharmacological approaches that present significant systemic toxicities to the recipient's body system. The invention is targeted at the receptor-ligand interactions between T-cells and other cells bearing antigenic determinants, where EGCG particularly blocks co-stimulatory molecules and their ligands thereby suppresses normal allostimulation of T-cells.

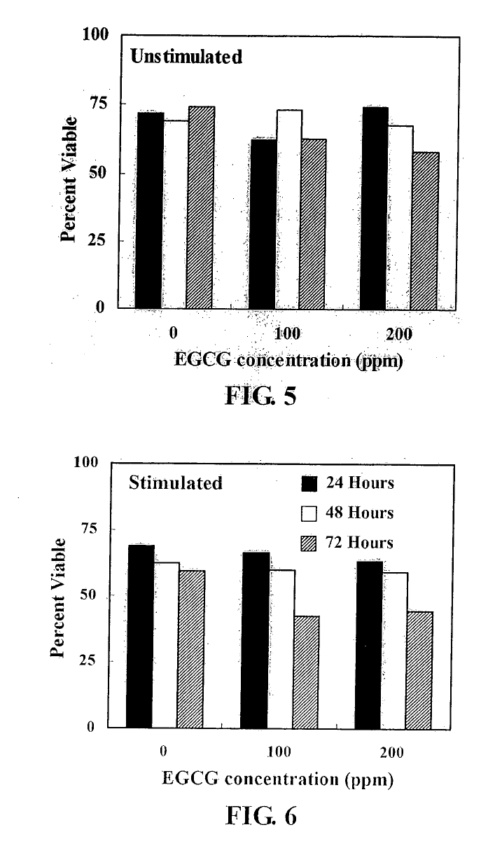

To evaluate the suppressive effect of the invention on the allostimulation, where T-cells play a major role in rejection of transplants, mixed lymphocyte reaction (MLR) was performed. MLR is a sensitive measure of histocompatibility between a donor and a recipient and indicates the probability of both graft survival in the recipient and the severity of GVHD. The results of MLR showed that EGCG effectively blocked allostimulation of T-cells in both cases when the responder cells or when the stimulator cells were treated with EGCG (FIGS. 3 and 4). This indicates that EGCG potentially attenuates the immune responses in allogenic rejection and GVHD, respectively. The attenuation of the proliferative responses was not due to a direct toxicity of EGCG to the cells (FIGS. 5 and 6).

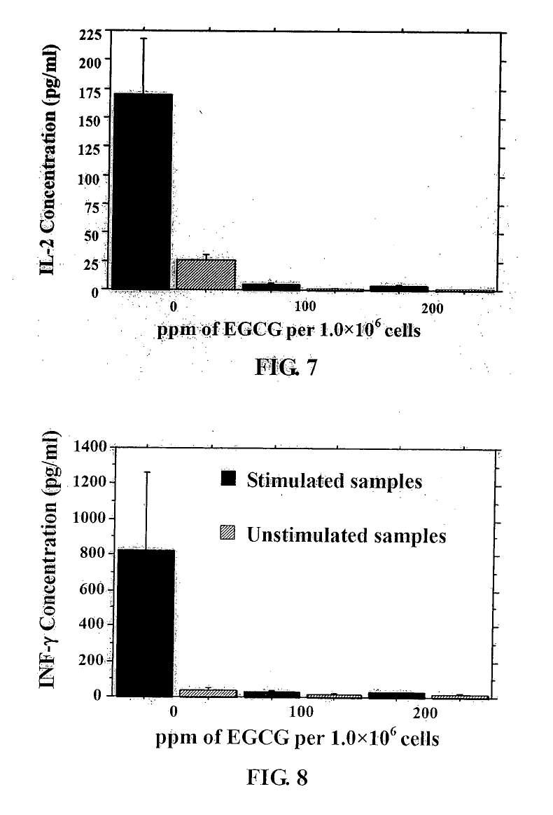

In vitro cytokine analyses of MLR supernatants further supported the attenuation of T-cell proliferation due to EGCG treatments. The concentrations of IL-2 and INF-γ in the EGCG-treated cultures were significantly lower than those in the untreated control (FIGS. 7 and 8), and the decreased levels of the cytokine production correspond with those of T-cell proliferation (FIGS. 3 and 4).

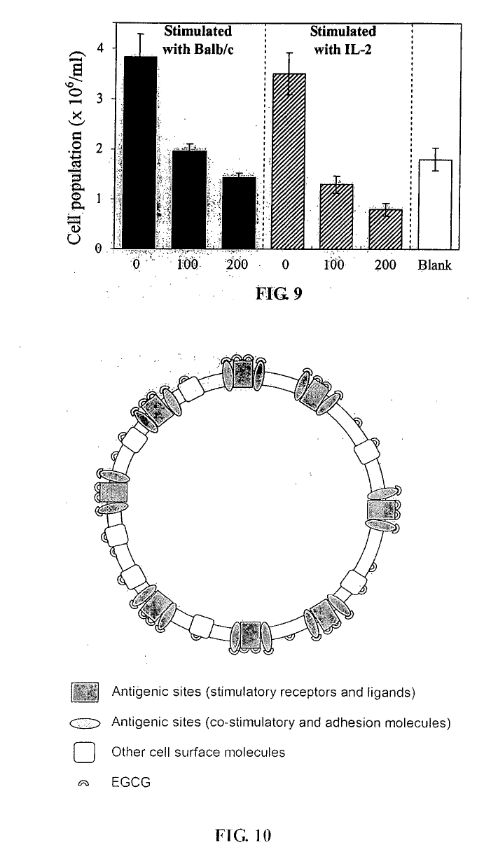

An example (EXAMPLE V) was also provided which relates to the possible mechanism of decreasing allogenic graft rejection (FIG. 9). The mechanism is the utilization of anergy. Anergy is developed by the first encounter of T-cells with foreign antigens, where the T-cells are incompletely stimulated by a significant blockage of co-stimulatory molecules such as CD28 and their ligands (CD80), while the interaction between T-cell receptor (TCRαβ) and major histocompatibility complex class II (MHCII) molecules (HLA II in humans) remains relatively intact (Turka et al. 1992; Gudmundsdottir and Turka 1999; Wells et al. 2000).

In fact, the lymphocyte marker analysis indicates that EGCG treatment hardly to moderately decreased the binding of TCRαβ and MHCII with their respective monoclonal antibodies, while it significantly decreased the binding of the CD28-specific monoclonal antibody down to about 50% of the control (TABLE 1). These findings suggest that the concentrations of EGCG used in the subject invention represent appropriate values for the potential occurrence of anergy. Other cell surface molecules were also blocked by EGCG In particular, CD3ε which is associated with TCR and important for the expression and signal transduction for the latter was strongly blocked. CD25, IL-2 receptor a chain and CD49d, an integrin α-related molecule, were also blocked by EGCG.

The invention thus provides for (1) the anergy-inducing cellular composition which upon encountering with T-cells prevents the stimulation of the latter, (2) the method of preparing such cellular composition, that is, treating of donor cells, tissues or organs with a media solution containing EGCG, (3) the prevention of rejection of the donor cells, tissues or organs treated with the media solution containing EGCG, and (4) the prevention of the propensity of T-cells remaining in the treated donor cells, tissues or organs toward attacking the recipient as a foreign entity.

### Materials and Methods

To evaluate the action of EGCG in rendering cells to become anergy-inducing, murine splenocytes were used as a model system. Splenocytes were collected from BALB/c (H2 K^{b}) and C57BI/6 (H2 K^{d}) female mice of 8 to 13 weeks of age in HBSS (BioWhittaker) with 1% FCS. Cells were washed with HBSS (1% FCS) and treated with the media solution which contains RPMI 1640 (Sigma-Aldrich), 10 mM HEPES (Dojindo), and various concentrations of EGCG (98% purity, Roche) described in the examples.

TABLE 1
Immunocmouflage of Cell Surface Epitopes

| | EGCg treatment concentration | | | | |
|---|---|---|---|---|---|
| Epitope | 0 ppm | 100 ppm | | 200 ppm | |
| CD3ε | 32.3 | 20.2 | (37.5)* | 5.6 | (82.7)** |
| TCRαβ | 31.0 | 29.9 | (3.5)^{n.s.} | 29.7 | (4.2)^{n.s.} |
| CD11a | 94.0 | 90.1 | (4.1)** | 90.0 | (4.3)** |
| CD2 | 94.9 | 85.9 | (9.5)** | 90.8 | (4.3)** |
| MHC class II | 43.8 | 32.5 | (25.8)** | 33.2 | (24.2)** |
| CD4 | 24.0 | 21.1 | (12.1)* | 20.8 | (13.3)* |
| CD25 | 13.9 | 11.6 | (16.5)^{n.s.} | 10.8 | (22.3)* |
| CD28 | 17.6 | 8.7 | (50.6)** | 9.4 | (46.6)** |
| CD49d | 42.9 | 19.7 | (54.1)** | 20.5 | (52.2)** |
| CD80 | 21.2 | 3.1 | (85.4)** | 9.7 | (16.4)** |

TABLE 1 lists a set of values representing the percent expression of cell surface molecules measured by flow cytometry using epitope-specific antibodies. Values in parentheses for EGCG-treated samples (100 ppm and 200 ppm) represent the average percent suppression in epitope detection relative to the untreated control samples (0 ppm). Each values is an average of a triplicate samples. Differences were significant (*p<0.03, **p<0.0001) or not significant (n.s.: p>0.05) compared with the untreated controls based on Fisher's PLSD.

### EXAMPLE I SURVIVAL OF MURINE SPLENOCYTES IN THE MEDIA SOLUTION CONTAINING EGCG

Murine splenocytes (C57BI/6) were suspended in the media solution containing 0, 200, and 1000 ppm EGCG with the cell concentration of 10⁶/ml, and 5 ml of this cell suspension was placed in six-well incubation plates and incubated at 4 or 37 degree C. for either 1 hr or 24 hours. Surviving cells were counted by trypan-blue exclusion method and direct observation under a high magnification (800×) by a compound light microscope (Nikon Eclipse TE300). The survival of the splenocytes was significantly low for the cells incubated for 24 hours (FIGS. 1 and 2). Cells incubated at 4 degree C. resulted in greater % survival than those incubated at 37 degree C. (FIGS. 1 and 2). Presented data are the average of three replicates for each treatment.

### EXAMPLE II MIXED LYMPHOCYTE REACTIONS (MLRS)

As shown in FIGS. 3 and 4, mixed lymphocyte reactions (MLRs) were performed by co-culturing two MHC-disparate murine splenocytes: BALB/c (stimulator cells) and C57BI/6 (responder cells) to evaluate the effect of EGCG in attenuating cells' antigenicity. In both one-way and two-way MLRs, EGCG treatments, whether for stimulator cells or responder cells, significantly decreased the proliferation of splenocytes. In a one-way MLR (FIG. 3), a stimulator splenocyte population (BALB/c) was treated with 30 ppm mitomycin C (MP Biomedicals) in RPMI 1640 (10% FCS) at 37 degree C. for 30 min. to arrest its proliferation before EGCG treatments. The splenocytes were then resuspended with the media solution (RPMI 1640 and 10 mM HEPES) containing 0, 100, and 200 ppm EGCG and incubated at 4-8 degree C. for 1 hour and twice washed with RPMI 1640 (10% FCS) before used for MLR experiments. In a two-way MLR (FIG. 4), both stimulator and responder populations were left capable of proliferating. Each cell population was resuspended in RPMI 1640 (10% FCS) and antibiotics: (penicillin 100 U/ml and streptomycin 100 ppm, BioWhittaker) to a final concentration of 5.0×10⁶ cells/ml. The stimulator and responder cells were mixed with a 1:1 ratio (120 μl each) and incubated in triplicate in 96-well plates for 72 hours at 3 degree C. and 5% CO₂. Cell proliferation was estimated by counting with trypan-blue exclusion a small sample of the cells from each MLR well.

### EXAMPLE III VIABILITY OF EGCG-TREATED SPLENOCYTES

Viability of EGCG-treated splenocytes were compared between unstimulated (C57BI/6 only) and stimulated (C57BI/6 co-cultured with BALB/c) cell populations cultured in media without EGCG In this example, splenocytes were washed with the culture media RPMI 1640 (10% FCS) to remove remaining EGCG in the cell suspensions immediately after EGCG treatments. As shown in FIG. 5 (Unstimulated), the proliferation did not significantly decreased throughout the incubation period. Thus, the attenuation of proliferation as indicated in the MLR experiments (Example II) was not largely due to an EGCG's direct toxicity to the splenocytes. The stimulated splenocytes (FIG. 6, Stimulated) showed time-dependent decrease in the viability of cells, which suggests that incomplete T-cell stimulation might be occurring. The experiments were performed as in Example II.

### EXAMPLE IV CYTOKINE ANALYSES FOR MLRS

Supernatants from the one-way MLR wells (Example II) were assayed for IL-2 and INF-γ production using cytokine quantification ELISA (e-Bioscience). As shown in the figures, the production of both IL-2 (FIG. 7) and INF-γ (FIG. 8) significantly decreased down to near or below the background levels of the unstimulated cultures. These cytokine data indicate that the stimulation and proliferation of T-cells were strongly attenuated by EGCG treatments.

### EXAMPLE V OCCURRENCE OF ANERGY

To find the evidence of anergy, fresh stimulator cells (BALB/c, 5.0×10⁶ cells/ml) as well as exogenous IL-2 (1.7 IU/ml) were added to one-way MLR cultures at 48 hours of incubation (EXAMPLE II), and the cultures were incubated for an additional 48 hours. As shown in FIG. 9, there was a subtle but significant suppression of T-cell proliferation for both treatments. Especially for the cell-stimulated cultures, EGCG suppressed the proliferation down to the level of unstimulated blank which represents splenocytes left unstimulated following the initial MLR. These results indicate that EGCG treatments influenced the occurrence of anergy.

### EXAMPLE VI LYMPHOCYTE MARKER ANALYSIS

Flow cytometric analyses of surface epitopes for the control and EGCG-treated splenocytes were performed using a series of fluorescence-labeled monoclonal anti-mouse CD and MHC and corresponding isotype control antibodies (eBioscience: CD2, CD36, CD4, CD11a, CD25, CD 28, CD 49d and CD80; Pharmingen: TCRαβ and MHC II). Murine splenocytes (C57BI/6) were treated with red blood cell lysis buffer (eBioscience) for 5 min prior to EGCG treatments. Immediately following EGCG-treatments, the splenocytes were washed with RPMI 1640 (10% FCS) and a staining buffer (eBioscience) at 4 degree C. Each splenocyte sample was reconstituted as a 50 μl aliquot in the same staining buffer and subject to antibody labeling. After washing twice the samples with the staining buffer, a minimum of 10,000 events per sample was collected on a Becton Dickinson FACScan flow cytometer. As shown in TABLE 1, for most of the tested epitopes except for TCRαβ, there was a significant suppression of antibody binding by EGCG treatments especially for costimulatory molecules such as CD28 and CD80. There was a dose-dependent reduction for CD3ε but not other epitopes, which suggests that for the latter the blocking ability of EGCG appeared to have reached saturation levels. This was probably due to the nonspecific binding of antibody molecules with the EGCG adhering to the cell surface antigens as indicated by the slight increases in the epitope expression values for 200 ppm treatments (CD11a, CD2, CD28 and CD49d).

### LIST OF REFERENCES CITED

Ashida, H. et al. (2000) Flavones and flavonols at dietary levels inhibit a transformation of aryl hydrocarbon receptor induced by dioxin. FEBS Letters 476:213-217.
Chen, A. M. and Scott, M. D. (2003) Immunocamouflage: Prevention of transfusion-induced graft-versus-host disease via polymer grafting of donor cells. J. Biomed. Mater. Res. 67A:626-636.
Falchetii, R. et al. (2001) Effects of resveratrol on human immune cell function. Life Sci. 70:81-96.
Gudmundsdottir, H. and Turka, L. A. (1999) T-cell co-stimulatory blockade: New therapies for transplant rejection. J. Am. Soc. Nephrol. 10:1356-1365.
Han, M.-K. et al. (2003) Epigallocatechin gallate, a constituent of green tea, suppresses cytokine-induced pancreatic β-cell damage. Exp. Mol. Med. 35:136-139.
Hyon, S.-H. and Kim, D.-H. (2001a) Long-term preservation of rat pancreatic islets under physiological conditions. J. Biotech. 85:241-246.
Hyon, S.-H. and Kim, D.-H. (2001b) Hibernation of Mammalian cells at a living body temperature. Biotechnol. Bioprocess Eng. 6:289-292.
Hyon, S.-H. (2004) A non-frozen living tissue bank for allotransplantation using green tea polyphenols. Yonsei Med. J. 45:1025-1034.
Hyon, S.-H. et al. (2005) Protection of human fibroblasts from reactive oxygen species by green tea polyphenolic compounds. Key Engineering Materials 288-9:665-668.
Ikeguchi, R. et al. (2005) Peripheral nerve allografts stored in green tea polyphenol solution. Transplantation 79:688-695.
Masten, S. A. (2001) Substances nominated to the NTP for toxicological studies and testing recommendations. Office of Chemical Nomination and Selection, Environmental Toxicology Program, National Institute of Environmental Health Sciences, NTP Inetragency Committee for Chemical Evaluation and Coordination (ICCEC), May 8, 2001.
Noguchi, H. et al. (2004) A new cell-permeable peptide allows successful allogeneic islet transplantation in mice. Nature Medicine 10:305-309.
Sazkuka, M. et al. (1996) Evidence for the interaction between (−)-epigallocatechin gallate and human plasma proteins fibronectin, fibrinogen, and histidine-rich glycoprotein. Biosci. Biotech. Biochem. 60:1317-1319.
Sanbongi, C. et al. (1997) Polyphenols in chocolate, which have antioxidant activity, modulate immune functions in humans in vitro. Cell. Immunol. 177:129-136.
Scott, M. D. et al. (1997) Chemical camouflage of antigenic determinants: “Stealth” erythrocytes. Proc. Nat. Acad. Sci. USA 94:7566-7571.
Scott, M. D. and Chen, A. M. (2004) Beyond the red cell: pegylation of other blood cells and tissues. Transfusion Clinique et Biologique 11:40-46.
Turka, L. A. et al. (1992) T-cell activation by the CD28 ligand B7 is required for cardiac allograft rejection in vivo. Proc. Natl. Acad. Sci. USA 89:11102-11105.
Wells, A. D. et al. (2000) CD28 co-stimulation and cell cycle progression are together necessary and sufficient for anergy avoidance in primary CD4+ T-cells. Transplantation 69: S130-S130.

1. An anergy-inducing cellular composition comprising:
a cell having a cell surface and antigenic degerminants of said cell surface; and
an anergy-inducing compound attached by chemical affinity to said antigenic determinants that are co-stimulatory molecules.

2. The cellular composition of claim 1 wherein said anergy-inducing compound is (−)-epigallocatechin-3-o-gallate (EGCG).

3. The cellular composition of claim 1 wherein said anergy-inducing compound is attached to the antigenic determinants by chemical affinity.

4. The cellular composition of claim 1 wherein said cell is a living cell that has said antigenic determinants.

5. The cellular composition of claim 1 wherein said antigenic determinants are co-stimulatory molecules.

6. A method of preparing an anergy-inducing cellular composition, said method comprising attaching said anergy-inducing compound to said antigenic determinants on a cell surface, wherein said antigenic determinants are co-stimulatory molecules.

7. A method of claim 6 wherein said cell is a living cell that has said antigenic determinants.

8. A method of claim 6 wherein said anergy-inducing compound is attached to the said antigenic determinants by chemical affinity by immersing said cell in a media solution containing said anergy-inducing compound.

9. A method of claim 8 wherein the concentration of said anergy-inducing compound in said media solution is between 50 and 500 ppm.

10. A method of claim 8 wherein the temperature at which said cell is immersed in said media solution is between 4 and 8 degree C.

11. A method of claim 8 wherein the duration of immersing said cell in said media solution is between 1 and 2 hours.

12. A method of claim 8 wherein said media solution is RPMI 1640.

13. A method of claim 8 wherein said media solution contains 10-20 mM 2-[4-(2-hydroxyethyl)-1-piperazinyl]ethansulfonic acid (HEPES).
